(19) United States
(12) Patent Application Publication
(10) Pub. No.: US 2013/0290940 A1
(43) Pub. Date: Oct. 31, 2013

(54) SYMBOL-BASED MERGING OF COMPUTER PROGRAMS

(71) Applicants: Balaji Palanisamy, Bangalore (IN); Satheesh Kumar Murugan, Roseville, CA (US)

(72) Inventors: Balaji Palanisamy, Bangalore (IN); Satheesh Kumar Murugan, Roseville, CA (US)

(21) Appl. No.: 13/538,449

(22) Filed: Jun. 29, 2012

(30) Foreign Application Priority Data
Apr. 25, 2012 (IN) 1622/CHE/2012

(51) Int. Cl. G06F 9/45

(52) U.S. Cl. 717/136

(57) ABSTRACT

Provided is a method of symbol-based merging of computer programs. A source program file and a destination program file, wherein the source file is a later generated version of the destination program file, is parsed to identify symbols present in the source program file and the destination program file. A mapping of the symbols present in the source program file and the destination program file is generated. From the mapping, symbols that were modified, added or deleted in the source program file since it was generated from the destination program file are identified. The identified symbols are merged.

### CLAIM FOR PRIORITY

The present application claims priority under 35 U.S.C. 119 (a)-(d) to Indian Patent application number 1622/CHE/2012, filed on Apr. 25, 2012, which is incorporated by reference herein in its entirety.

### BACKGROUND

In a typical software development environment there could be instances where an initial program file may undergo modification at the hands of different people or at different periods in time. For instance, an initial program file may be modified by two developers working independently of each other. In such cases, it is often desirable that changes made by these individuals are merged with the original program file.

### BRIEF DESCRIPTION OF THE DRAWINGS

For a better understanding of the solution, embodiments will now be described, purely by way of example, with reference to the accompanying drawings, in which:

FIG. 1 shows an example scenario where symbol-based merging of computer programs may be used, according to an embodiment.

FIG. 2 shows a flow chart of a method of symbol-based merging of computer programs, according to an embodiment.

FIG. 3 illustrates various stages of block 206 of FIG. 2, according to an embodiment.

FIG. 4 illustrates a computer for implementing the method of FIG. 2, according to an embodiment.

### DETAILED DESCRIPTION OF THE INVENTION

In a software development environment, there could be instances when a software developer may integrate a third party code or an open source code with his proprietary code. Although it might be convenient initially (and even necessary, for example, if it is a client requirement) the incorporation of a third party code or an open source code into a proprietary code may cause problems subsequently. For instance, the vendor of a third party code may make modifications and release new versions of his software. In such situations, it becomes difficult for a proprietary code developer to continuously integrate and keep up-to-date with an updated version of the third party software. It could not only be a time consuming affair but also a tedious exercise since the code in the third party software may get moved or reorganized across different files. Additionally, the file names or file locations may change, or Application Programming Interfaces (APIs) may get moved or deleted, making the integration process a tricky task.

Further, in the course of release of different versions of a software, program files and code structure may get modified such that various symbols of a program code may get distributed across multiple files. In such cases, a file-based merge tool will also not work since the code orientation may have changed.

Proposed is a system and method of merging computer programs (machine readable instructions or program code) which may be present in two or more computer files. Specifically, proposed is a system and method of a symbol-based merging of computer programs present in separate files.

For the sake of clarity, the term “symbol” may be defined as an element that allows the system to use the same source code for two or more unique instances of the same program. Symbols represent the variable information in a program.

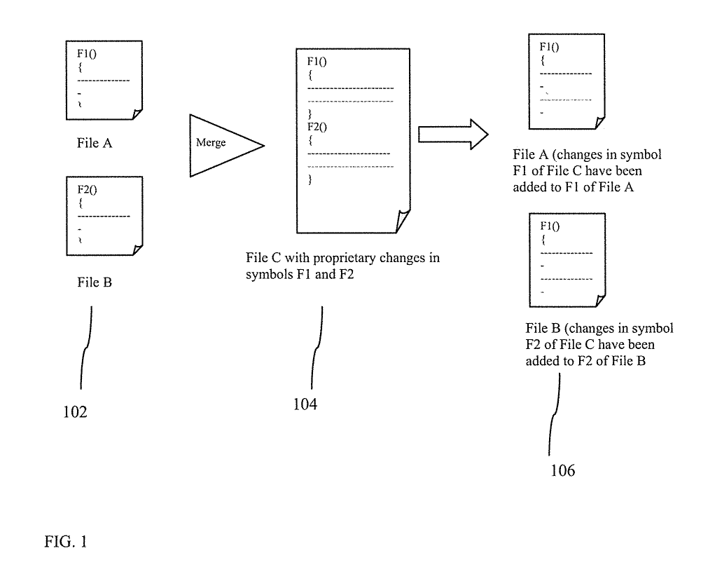

FIG. 1 shows an example scenario where symbol-based merging of computer programs may be used, according to an embodiment.

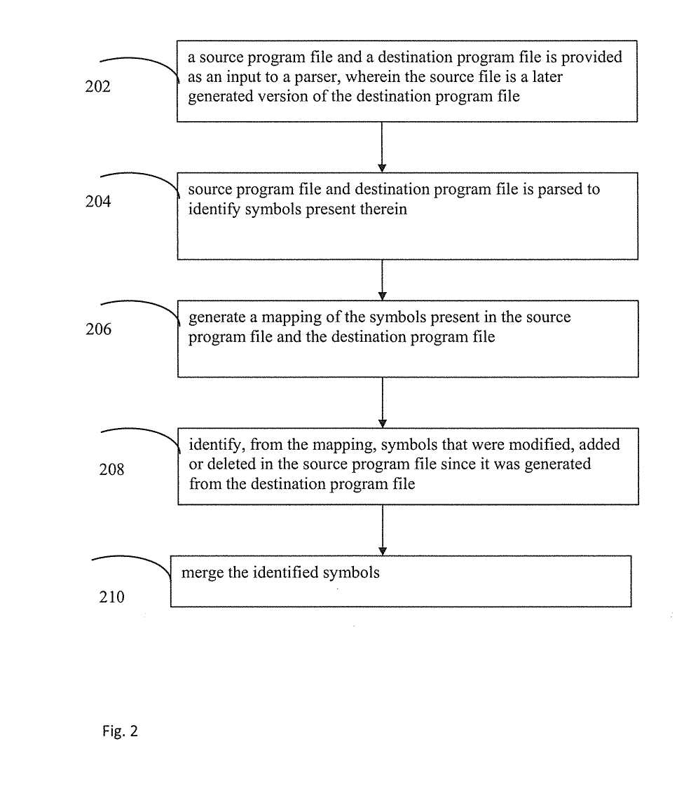

In the example illustrated in FIG. 2, functions F1( ) and F2( ) are in two different files (File A and File B respectively) in version 1 of a software release (102). In the next version (version 2), functions F1( ) and F2( ) are moved to a single file, File C (104). However, prior to their movement to a single file in version 2, proprietary changes (for example, code addition/modification/deletion) are made to functions F1( ) and F2( ). Therefore, in this example, not only symbols (functions F1( ) and F2( ) get moved but proprietary code is added to the symbols. In this scenario, if one wants to update version 1 with version 2 changes, i.e. create output files 106 (where changes in function F1( ) of File C have been added to function F1( ) of File A, and changes in function F2( ) of File C have been added to function F2( ) of File B), a typical file-based merge tool will not work since symbols have moved during version upgrade.

FIG. 2 shows a flow chart of a method of symbol-based merging of computer programs, according to an embodiment.

At block 202, a source program file and a destination program file is provided as an input to a parser. To provide some non-limiting illustrative examples, a source program file may be a new version of software (for instance, proprietary software), a new version of a third party software, and/or a new version of open source software. A destination program file may be an existing or an earlier version of software (for instance, proprietary software), an earlier version of a third party software, and/or an earlier version of open source software. Therefore, in an example, a source program file may be a modified version of a destination program file. A source program file may have been created by modifying, adding and/or deleting segments of the program code in a destination program file. A source program file may be generated by directly or indirectly modifying a destination file. A source program file is said to be indirectly generated from a destination program file when there are intervening additional file(s) between the destination file and the source file. The intervening additional file(s) represent different stages of modification that a source file may undergo before a destination file is generated. If a source program file is a modified version of a destination program itself, it is said to be directly generated.

At block 204, the parser parses the program code in the source and destination files, and identifies symbols present in the program code of these files. The parser may also record metrics such as file name of the source and destination files, number of lines in these files, line number of symbols, etc. While identifying the symbols present in the program code of the source and destination files, the parser may also build a symbol database.

At block 206, once the program code in both the source and destination files has been parsed, the parser generates a symbol mapping in a markup language. In an example, the markup language is the Extensible Markup Language (XML). The parser parses the program code in the source and destination files and generates a mapping file which includes all the symbols that are present in the source and destination files. The mapping contains entries of all the symbols in the input files.

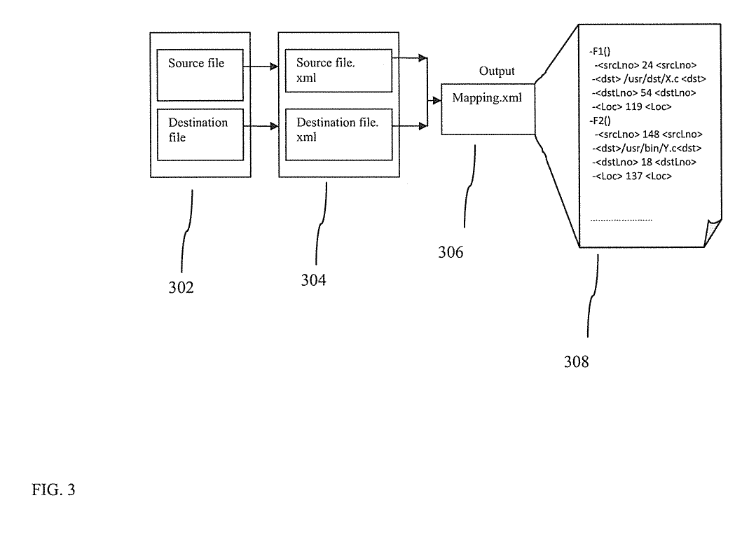

FIG. 3 illustrates various stages of block 206 of FIG. 2 in detail. At block 302, program code of both a source and destination file is parsed to generate individual symbol files for each of these files. A symbol file captures all the symbols that may be present in a file (source or destination). A symbol file for a source file is generated which captures the symbols present in the source file. Similarly, a symbol file for a destination file is generated which captures the symbols present in the destination file. The symbol files may be generated in a markup language 304. In an example, the markup language may be the Extensible Markup Language (XML). At block 306, symbol files of both the source and destination files are combined to generate a mapping file (for example, mapping.xml, 308) which includes all the symbols that are present in the source and destination files.

To provide an illustration of a symbol mapping in a markup language, let's consider a symbol, a function F1( ) which has been moved from File A in version 1 of a software release to File B in version 2 of the release. A mapping XML entry of this symbol, function F1( ) may include the following details: source and/or destination file names (File A/File B), line number at the source and/or destination files where the symbol is located, and number of lines in source and/or destination files. The aforementioned details are merely illustrative and further metrics may be added to identify whether a symbol could be changed or not.

As mentioned earlier, a source program file may be a modified (or subsequent) version of a destination program file. In other words, a source program file may have been generated by modifying, adding and/or deleting segments of the program code in a destination program file. At block 208, symbols that have been modified, added and/or deleted during the generation of a source program file from a destination program file are identified. In other words, symbols that have changed in the source program file since it was generated from a destination file are identified.

In an example, the mapping file is used to determine whether a symbol has been modified since the destination file was generated. By using the mapping file (for example, a mapping XML file if XML is used as the markup language), each symbol is extracted to temporary files from the source and destination files, and compared using a file diff tool to determine whether a symbol has been modified or not. Symbols that are identified as having been modified are extracted from the symbol mapping XML file to form a diff XML file.

A diff XML file generated between two versions of a program file (for example, between a source program file and a destination program file), is used to obtain a list of symbols that have been modified, added and deleted between the two versions.

At block 210, symbols listed in the diff XML file are merged. The symbols from both the source and destination files are extracted to a temporary file and merged using a file merge tool. There are many tools available that perform an auto merge when the changes are not conflicting, and also prompt for a manual decision in case of conflicting changes.

Once the merger between the symbols is complete, the corresponding symbols at the destination file are replaced with the merged output. All the symbols in the diff XML file get merged with the corresponding symbols in the destination file leading to program code of the destination program file getting updated with the program code of the source file.

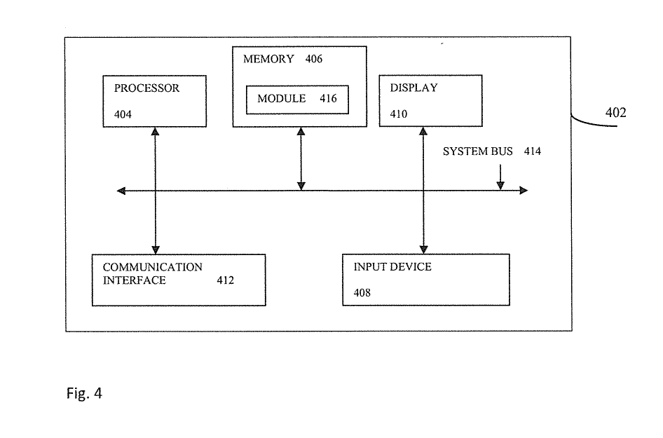

FIG. 4 illustrates a computer for implementing the method of FIG. 2, according to an embodiment.

Computer 402 may be a personal computer (PC) (for example, a desktop computer, a notebook computer, a net book, etc.), a touchpad, computer server, a mobile phone, a personal digital assistant (PDA), and the like.

Computer 402 may include a processor 404 (for executing machine readable instructions), a memory 406 (for storing machine readable instructions), an input device 408, a display 410 and a communication interface 412. The aforesaid components may be coupled together through a system bus 414.

Processor 404 is arranged to execute machine readable instructions. The machine readable instructions may be in the form of a software program. In an example, processor 404 executes machine readable instructions to: parse a source program file and a destination program file, wherein the source file is a later generated version of the destination program file; identify symbols present in the source program file and the destination program file; generate a mapping of the symbols present in the source program file and the destination program file; identify, from the mapping, symbols that were modified, added or deleted in the source program file since it was generated from the destination program file; and merge the identified symbols. In an example, the machine readable instructions may be in the form of a module 416, which may be present in memory 406. The term “module”, as used in this document, may mean to include a software component, a hardware component or a combination thereof. A module may include, by way of example, components, such as software components, processes, functions, attributes, procedures, drivers, firmware, data, databases, and data structures. The module may reside on a volatile or non-volatile storage medium and configured to interact with a processor of a computer system.

Memory 406 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc.

Input device 408 may be used to provide a user input to computer 402. Input device may include a keyboard, a mouse, a touch pad, a trackball, and the like.

Display device 410 may be any device that enables a user to receive visual feedback. For example, the display may be a liquid crystal display (LCD), a light-emitting diode (LED) display, a plasma display panel, a television, a computer monitor, and the like.

Communication interface 412 is used to communicate with an external device, such as a switch, router, a phone, etc. Communication interface 412 may be a software program, a hard ware, a firmware, or any combination thereof. Communication interface 412 may use a variety of communication technologies to enable communication between computer 402 and an external device. To provide a few non-limiting examples, communication interface may be an Ethernet card, a modem, an integrated services digital network (“ISDN”) card, etc.

It would be appreciated that the system components depicted in FIG. 4 are for the purpose of illustration only and the actual components may vary depending on the computing system and architecture deployed for implementation of the present solution. The various components described above may be hosted on a single computing system or multiple computer systems, including servers, connected together through suitable means.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of symbol-based merging of computer programs, comprising:
parsing a source program file and a destination program file, wherein the source file is a later generated version of the destination program file;
identifying symbols present in the source program file and the destination program file;
generating a mapping of the symbols present in the source program file and the destination program file;
identifying, from the mapping, symbols that were modified, added or deleted in the source program file since it was generated from the destination program file; and
merging the identified symbols.

2. The method of claim 1, wherein identifying, from the mapping, the symbols that were modified, added or deleted in the source program file since it was generated from the destination file includes extracting each symbol, from the source program file and the destination program file, to a temporary file and determining using a file comparison program whether the symbol was modified.

3. The method of claim 1, further comprising extracting the identified symbols to another file prior to their merger.

4. The method of claim 1, wherein parsing the source program file and the destination program file includes recording file names of the source program file and the destination program file, determining number of program lines in the source program file and the destination program file, and/or identifying line number of the symbols present in the source program file and the destination program file.

5. The method of claim 1, wherein the mapping of the symbols present in the source program file and the destination program file are stored in a separate file.

6. The method of claim 1, wherein the source program file is a direct or indirect modification of the destination program file.

7. The method of claim 1, wherein the source program file is a third party program file and the destination program file is a proprietary program file.

8. The method of claim 1, wherein the source program file is an open source program file and the destination program file is a proprietary program file.

9. The method of claim 1, wherein the mapping of the symbols present in the source program file and the destination program file is in a markup language.

10. The method of claim 9, wherein the markup language is Extensible Markup Language (XML).

11. A system, comprising:
a processor;
a memory communicatively coupled to the processor, the memory comprising machine executable instructions that, when executed by the processor, causes the processor to:
parse a source program file and a destination program file, wherein the source file is a later generated version of the destination program file;
identify symbols present in the source program file and the destination program file;
generate a mapping of the symbols present in the source program file and the destination program file;
identify, from the mapping, symbols that were modified, added or deleted in the source program file since it was generated from the destination program file; and
merge the identified symbols.

12. The system of claim 11, wherein the machine executable instructions include a parser that builds a database of symbols present in the source program file and the destination program file.

13. The system of claim 11, wherein the source program file is a third party program file and the destination program file is a proprietary program file.

14. The system of claim 11, wherein the source program file is an open source program file and the destination program file is a proprietary program file.

15. A non-transitory computer readable medium, the non-transitory computer readable medium comprising machine executable instructions, the machine executable instructions when executed by a computer causes the computer to:
parse a source program file and a destination program file, wherein the source file is a later generated version of the destination program file;
identify symbols present in the source program file and the destination program file;
generate a mapping of the symbols present in the source program file and the destination program file;
identify, from the mapping, symbols that were modified, added or deleted in the source program file since it was generated from the destination program file; and
merge the identified symbols.
